(19) United States
(12) Patent Application Publication
(10) Pub. No.: US 2010/0304714 A1
(43) Pub. Date: Dec. 2, 2010

(54) DIGITAL CONTENT TRADING SYSTEM AND METHOD APPLIED TO MOBILE APPARATUS

(75) Inventors: HSIANG-HUA CHAO, TAIPEI (TW); CHI-CHEN CHENG, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: IPEER MULTIMEDIA INTERNATIONAL LTD., TAIPEI (TW)

(21) Appl. No.: 12/727,583

(22) Filed: Mar. 19, 2010

(30) Foreign Application Priority Data
May 27, 2009 (TW) 098117750

(51) Int. Cl. G06Q 50/00; H04M 1/66; G06F 21/22; G06Q 20/00; G06Q 30/00

(52) U.S. Cl. 455/411; 705/59; 705/53; 726/26

(57) ABSTRACT

A digital content trading system and the method applied to a mobile apparatus are disclosed. The mobile apparatus particularly provides communication and multimedia playback functions. The claimed system and method embody a trading mechanism among the mobile apparatus, a telecommunication company, and a digital content provider. A Short Message Service transmitted between the mobile apparatus and the telecommunication company is used for verifying the trading. A registration signal will be sent to the mobile apparatus after verifying the transaction. After that, the digital content preinstalled in the mobile apparatus is completely applicable. A commercial method applied to the digital content trading achieves consequently.

### BACKGROUND OF THE INVENTION

1. Field of the Invention

The present invention relates to a digital content trading system and a method therefor, more particularly to a business model being applied among a mobile communication apparatus, a mobile communication provider, and a digital content provider.

2. Description of Related Art

With development of various functions for mobile phones, playing multimedia becomes one of the basic functions. Besides the portable MP3 player, users are getting used to utilize the mobile phone to be the device playing multimedia.

The various devices used for playing multimedia usually utilize a computer capable of networking to retrieve multimedia content. Such as iTune of Apple™ Inc., the multimedia player, iPod connects to the computer with iTune to download the multimedia contents through network. The connection relation is shown in FIG. 1, which illustrates a schematic diagram of downloading multimedia contents to a mobile communication apparatus via a computer.

In the figure, the mobile communication apparatus 14 connects to a computer system 10 via a connection line. For example of a multimedia player, the player 14 downloads the multimedia from network through the computer system 10, or retrieves the multimedia files from a disc. The computer system 10 may have multimedia transmission software 12 installed, and the software 12 provides an interface for transmitting the multimedia. The multimedia is then transmitted to the mobile communication apparatus 14 or other players.

FIG. 2 shows another conventional art that utilizes network to process trading of the multimedia content. Thereby the users may purchase the multimedia provided by a digital content provider 24 via a trading interface and network functionality of a computer system 22. Under the system described in the figure, a mobile communication apparatus 28 connects to Internet 20 via the computer system 22. The digital content provider 24 provides a trading mechanism via network. By means of a software interface launched by the computer system 22, the users preferably use a credit card or a value-stored card to purchase the multimedia.

Such as iTune introduced by Apple™ Co., registration of a credit card for trading is required. Through an agreement settled between the digital content provider 24 such as Apple™ Co. and a bank 26, it is to achieve an objective of the trading. So that, the users may download the legal content from the provider 24, and transmit to the mobile communication apparatus 28.

In general, the multimedia player needs to connect to the computer system for downloading the multimedia through the network capability and interface. Other apparatuses have built-in networking module, such as 3 G, 3.5 G or WiFi, by which they can access the multimedia. Some drawbacks, such as small operation area and inconvenient interface, still exist.

### SUMMARY OF THE INVENTION

In order to retrieve the multimedia, especially through network, the conventional multimedia player utilizes a computer system to access the network, or the device has its own networking capacity therefor. Further, the conventional player also needs to use a specific software interface to process an online trading of multimedia. In contradistinction, the present invention discloses a digital content trading system and a method applied to a mobile apparatus. Particularly a business mode is provided since digital content is pre-installed in the mobile apparatus. Alternatively, the trading method relates to the digital content being downloaded through the network functioned in the mobile apparatus.

The present invention is mainly applicable to the digital content, such as video, audio, image or text, pre-installed in a mobile apparatus. A user may preview the digital content as it can be an advertisement. Furthermore, the preview provides a chance for the user to make a trading selection. In the preferred embodiment, the user particularly uses a short message transmitted to the mobile communication provider to verify the online trading of the digital content. Next, after the mobile communication provider confirms the action with the digital content provider, the digital content provider provides a registration of the content. The user can access the full and selected digital content consequently.

The preferred embodiment of the digital content trading method of the present invention includes a first step of initiating the digital content in a mobile apparatus. The first step is actually a preview stage for the digital content. Next, a purchase signal is transmitted and a mobile communication provider verifies the signal. The mobile communication provider then informs a digital content provider. Next, a registration signal is transmitted to the mobile apparatus for conducting a registration for the digital content. Then the user may access the full digital content.

As described above, the mobile communication provider may conduct the payment by a bill after the provider verifies the payment. If the user uses a value-stored method to make the payment, the deduction for the payment is confirmed immediately. More particularly, the present invention provides the user to access the digital content temporarily in a period of time. The user may access the multimedia immediately even not yet registered. After verifying the payment and receiving the related registration signal, the user can access full multimedia without time limit.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a mobile apparatus having a multimedia installed;

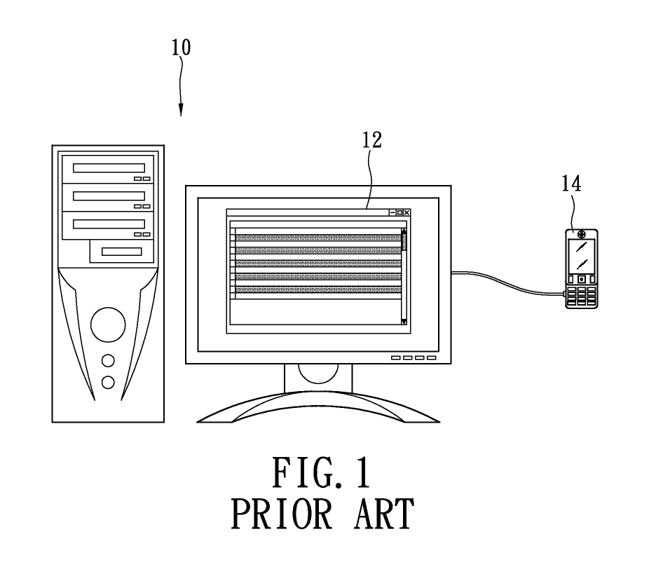

FIG. 2 shows a conventional structural diagram of a trading system for online multimedia;

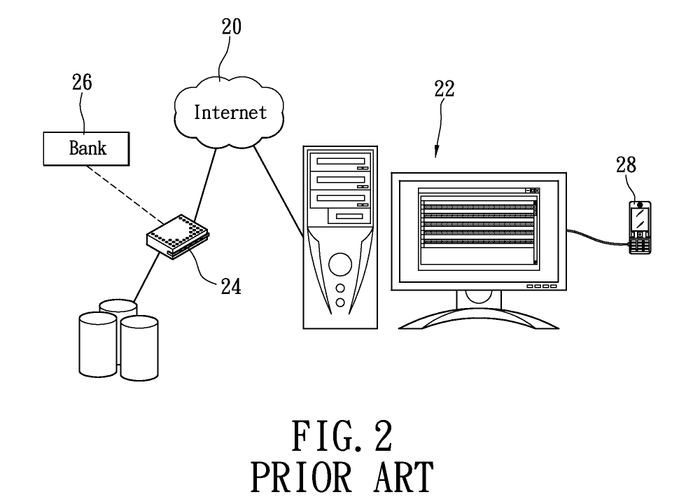

FIG. 3 shows a schematic diagram of the digital content trading system applied to the mobile apparatus;

FIG. 4 shows flow chart of the digital content trading method applied to the mobile apparatus of a first embodiment of the present invention;

FIG. 5 shows a schematic diagram of the digital content trading method adapted to a mobile apparatus of the present invention;

FIG. 6 shows flow chart of the digital content trading method applied to the mobile apparatus of a second embodiment of the present invention;

FIG. 7 shows flow chart of the digital content trading method applied to the mobile apparatus of a third embodiment of the present invention.

### DETAILED DESCRIPTION OF THE PREFERRED EMBODIMENTS

In current market, the mobile phones on sale have inside memories, or equipped with external memories. In one of the embodiments of the present invention, the inside memory may pre-install some digital contents. The pre-installed digital contents may be a full version or a preview version that have a part of the content. Those pre-installed digital contents are provided to users for convenient purchase, or alternatively to the product providers for advertisement.

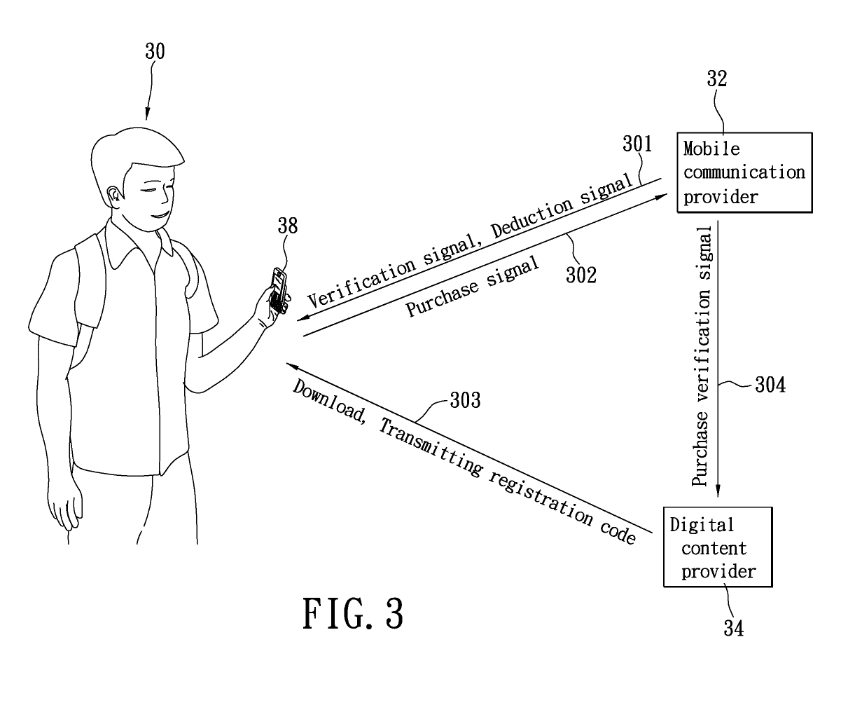

The digital content trading system applied to the mobile apparatus of the present invention is to provide a trading mechanism for the users through a downloaded menu. Reference is made to FIG. 3 illustrating a structure of the claimed digital content trading system of the present invention.

As shown in the diagram, the system preferably has relationship of a triangle, including the user ends (30, 38) with mobile apparatuses, a mobile communication provider (32), and a digital content provider (34).

The user end 30 has a portable mobile apparatus 38, which at least needs a functionality of playing digital content. By the mobile apparatus 38, the user can access the inside digital content directly. The mobile apparatus 38 further requires the functionality of communication for transmitting messages, such as to transmit short message. Moreover, the wireless communication protocol, such GPRS, 3 G, 3.5 G, or WiFi, is required to communicate with a remote server. Decryption function is also required since the pre-installed digital content or the downloaded content has been encrypted before conducting registration. Therefore, the copyright of the digital content can be protected well. Provided is the decryption technology of the present invention, the digital content is decrypted as receiving a legal registration code if a payment action is verified. The user can legally access the full digital content after obtaining a fully privilege by registration.

The mobile communication provider 32 provides a communication service for the mobile apparatus 38, including the various wireless communication services. In the present invention, the mobile communication provider 32 not only provides the communication service, but also a service of deduction for the payment. The payment services include payment by a bill and real-time deduction by a value-stored mechanism.

Under the claimed system structure, the user 30 previews the digital content in the mobile apparatus 38, and decides to purchase a full version of the digital content. Meanwhile, a purchase signal 302 is transmitted to the mobile communication provider 32. Next, the mobile communication provider 32 issues a verification signal and a deduction signal 301, so as to complete a verification procedure. In another embodiment, the user is required to confirm the purchase action.

The digital content provider 34 in the claimed system has a database, in which the various types of digital contents are stored. In practical implementation, there are plural digital content providers provide their contents to the database of the system, or those digital content providers cooperatively build a joint service platform.

The digital content provider 34 at least has capability of wireless communication, which is used for providing the digital contents to be downloaded. The communication is preferably a network connection for transmitting registration code 303. A digital content broadcasting means is further provided to transmit the full version of the digital content. A registration code generating means is provided to receive a message of successful deduction for the payment (that is to issue a purchase verification signal 304) and generate registration signal, from the mobile communication provider 32. The digital content provider 34 transmits the corresponding registration signal to the mobile apparatus 38 according to the identification information recorded in the mobile apparatus 38. More particularly, the present invention provides a secure and well-protection mechanism for broadcasting the digital content since the proprietary registration code is transmitted under a mobile communication protocol and based on the identification of the mobile apparatus 38.

FIG. 3 shows a schematic diagram of digital content trading system applied to the mobile apparatus of the present invention. Thereby users can legally and conveniently access full multimedia pre-installed in the mobile apparatus 38. The pre-installed digital content can also be a part of the multimedia for preview. Users can legally and conveniently download a full version of the multimedia through the above-described trading mechanism. Alternatively, the digital content can be downloaded through a downloaded menu. The user may select one item to be downloaded. Preferably both full version and preview version digital content are provided in the menu for legally accessing by the trading mechanism.

Since a usual mobile phone system is incorporated, the message between the mobile apparatus 38 and the mobile communication provider 32 is preferably implemented as a short message.

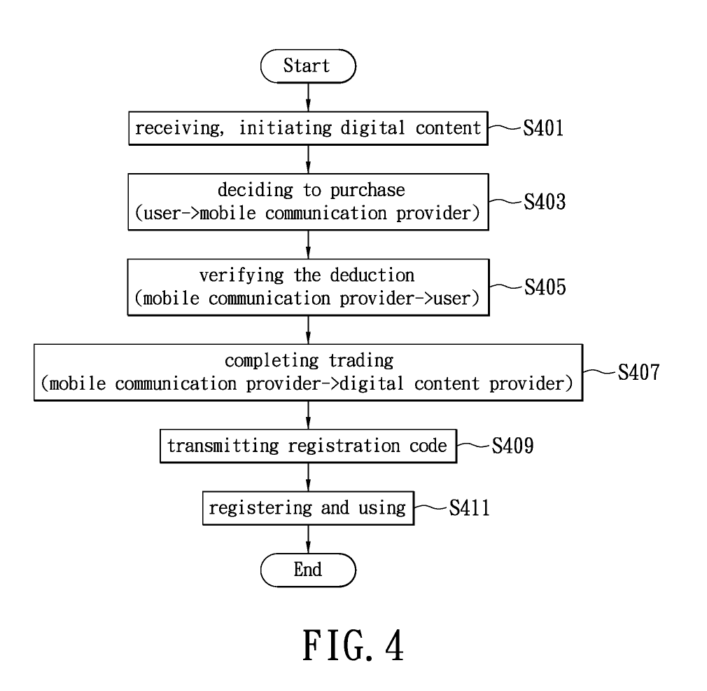

FIG. 4 shows a flow chart of the digital content trading method of the preferred embodiment of the present invention. This flow chart is particularly illustrating an aspect of the claimed steps.

In the beginning, a user initiates a digital content pre-installed in a mobile apparatus, and it is generally a preview stage for the user to play music or watch video (step S401). When the user decides to purchase a selected digital content, a purchase signal is generated and transmitted to a mobile communication provider. The purchase signal is preferably sent by a short message (step S403). After the mobile communication provider receives the purchase signal and the purchase signal is identified. The related deduction for the payment is then verified. In one embodiment, the process of verifying the deduction can be ignored at current stage. For example, if the user pays the fee for the communication monthly, the charge will be listed on a monthly bill, and the user pays the bill including the charge for the digital content. If the user pays the fee by a value-stored card, the mobile communication provider needs to ascertain the balance of the stored value for the payment. Since the balance is sufficient for the payment, the charge will be deducted from the balance immediately.

In one embodiment of the present invention, a verification signal is transmitted to the mobile apparatus from the mobile communication provider. The user can thereby confirm the deduction for the payment by the bill or stored value. A short message can record the information relating the digital content and the fee (step S405).

After ascertaining the payment, the mobile communication provider notifies the digital content provider regarding accomplishment of the trading (step S407). When the digital content provider verifies the trading, a related registration signal is generated and transmitted to the user-end mobile apparatus according to the related information (step S409). The information includes the apparatus' serial number, SIM card number, or chip number. The registration signal can be a serial number corresponding to a digital content. The serial number is used to conduct the registration in the mobile apparatus. The digital content can be fully accessed (step S411).

The mentioned digital content can be a form pre-installed in a memory of the mobile apparatus. The pre-installed content can be a full version of multimedia, or a part of the multimedia. Furthermore, the digital content can be downloaded multimedia after a selection made by the user from a menu. Since the multimedia is not yet registered in the beginning, the multimedia is at preview stage or a relevant advertisement. The multimedia can be fully accessed after successful registration. If the multimedia pre-installed in the memory is not a full version, the user is authorized to download.

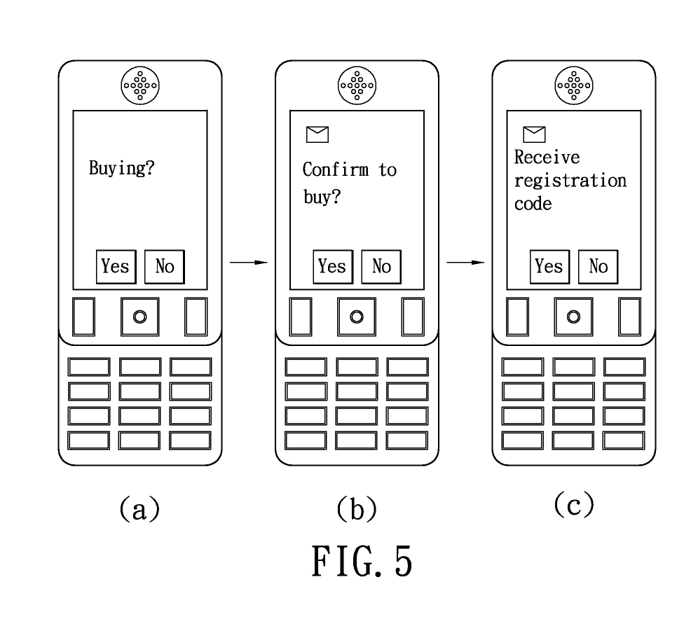

Reference is made to FIG. 5 illustrating an exemplary example of the digital content trading method applied to the mobile apparatus. This figure shows a message displayed on the screen of the user-end mobile apparatus when the claimed trading system works.

As shown in FIG. 5(a), a reminder about a question of buying or not is displayed. This reminder preferably pops up on the screen of the mobile apparatus after the user previews the digital content for a period of time. The reminder can also have some information relating the digital content, such as title, author name, capacity and the fee. At the moment, the user may decide whether to buy a full version of the digital content. If the user desires to buy by choosing “yes”, a purchase signal is created and sent as a short message preferably.

After receiving the purchase signal, as shown in FIG. 5(b), the mobile communication provider responds a message of confirmation of the payment. The message may be accompanied with the information of the digital content. The user may confirm the message. But this procedure of confirmation may be ignored. The related embodiment can be done as the user issues the purchase signal as shown in FIG. 5(a). The payment can be deducted by a bill or immediately by a stored value.

If the user confirms the payment, the claimed system of the present invention conducts the deduction for the payment from the mobile communication provider. In a preferred embodiment, the fee for the payment will be added on a list of the communication bill. Therefore, no more action through bank or other complicated payment mechanism is required.

Moreover, the mobile communication provider will notify the related digital content provider after the user confirms the payment. The digital content provider will transmit a corresponding registration signal to the user-end mobile apparatus. In practical, a registration code as a serial number regarding the chosen digital content is transmitted. As shown in FIG. 5(c), the user confirms to receive the registration code, it appears a verification message of whether or not to receive a registration signal on the screen. The registration code is particularly used to decrypt the pre-installed content so that the digital content can be fully accessed. Alternatively, it's not necessary to query the user whether or not to receive the registration, but directly perform the registration process.

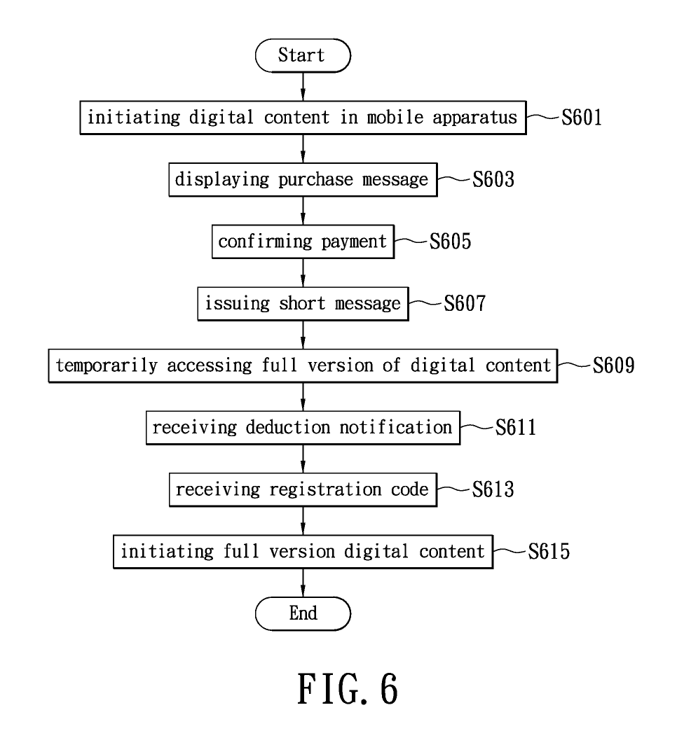

The digital content trading method of the second embodiment of the present invention is shown as a flow chart of FIG. 6.

The one or more digital contents are pre-installed in the memory of the mobile apparatus. When the user initiates the digital content using the mobile apparatus, the first stage is a preview stage that the digital content is permitted to be accessed in a limited time (step S601). After initiation, a reminder with a query about whether or not to buy will be displayed within a certain period of time (step S603). The user, at this moment, can decide to buy or not (only in the preview stage).

If the user confirms to purchase the digital content (step S605), in a preferred embodiment, a short message will be created and sent to the mobile communication provider (step S607). The present invention provides the user temporarily accessing the full version of the digital content in a limited period since the content is not successfully registered (step S609). The mechanism can prevent the error occurred on registration procedure since the error may make the user failing to access the content immediately. However, the temporary privilege of full access has time limit until the deduction for the payment is verified and the related registration code is received.

Next, as receiving the purchase signal, the mobile communication provider identifies the signal source and the chosen digital content, a response (preferably a short message) is transmitted to the mobile apparatus since the payment action is verified. The user then receives a notification of deduction for the payment (step S611). There is a verification procedure for the payment hold between the mobile communication provider and the digital content provider. The payment mechanism includes a deduction by a bill, or by a value-stored card. The digital content provider finally issues the registration code. After the mobile apparatus receives the registration code (step S613), the digital content is fully initiated since the registration code (preferably a serial number) is used to decrypt the content.

More particularly, the message may be lost in the step of verifying the deduction for the payment since the communication quality is unstable or broken. Therefore, the mobile communication provider may periodically re-verify the deduction in a certain period of time. During this re-verification period, the user may still access the full version of the digital content temporarily. When this period expires, the privilege of fully access is closed.

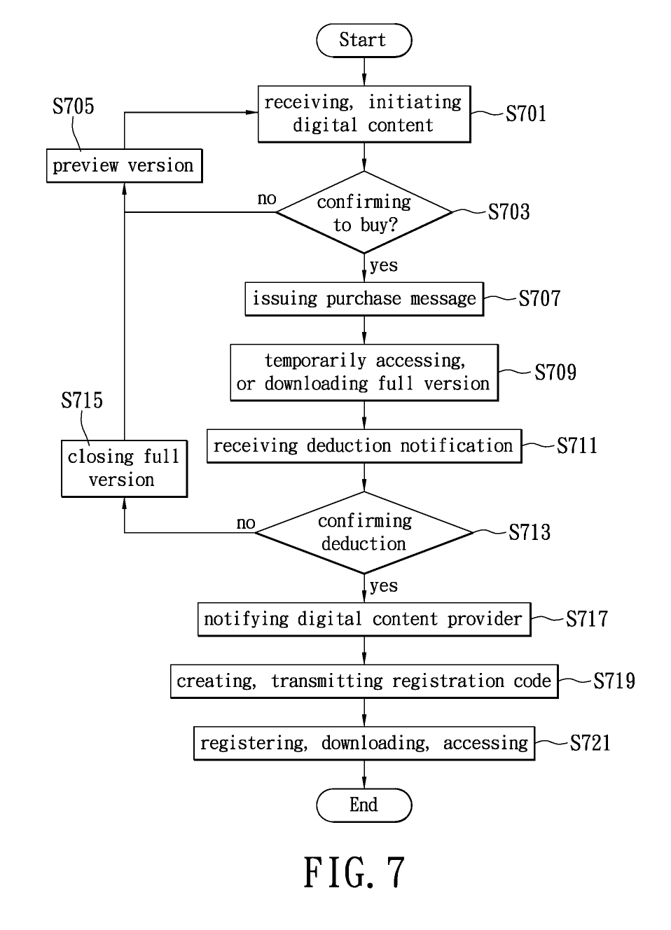

FIG. 7 shows a flow chart of the third embodiment of the claimed method.

A detailed flow chart is shown in the figure. In the beginning, a user retrieves or downloads one or more digital contents through a mobile apparatus, or initiates the digital content pre-installed in the memory of the mobile apparatus. (step S701). After previewing the content, a message is displayed on the screen, and used for confirm whether or not to buy the digital content (step S703). If the user denies the action, he can still access the preview version of the digital content (step S705).

If the confirmation is conducted as “yes”, the mobile apparatus issues a purchase message (short message) (step S707). In the meantime, the user may temporarily access the full digital content, or download the full version by a mobile network protocol (step S709). It is noted that the digital content is not yes registered at current stage.

Next, a signal is sent as the mobile communication provider verifies the payment, and the mobile apparatus may receive a notification of deduction for the payment (step S711). In the current embodiment, the signal is used for the user reconfirming the payment (step S713).

If the user desires to withdraw the decision of payment at this moment, the temporary privilege of fully access will be closed (step S715).

In another embodiment, there is no need to reconfirm the payment, and the user may immediately access the full digital content for a limited period of time. Until the deduction for the payment is verified or the registration signal is received, the digital content can be fully accessed without any time limit. Otherwise, if the user denies to receive the registration code or the deduction for the payment fails after a period of time, the full access of the digital content will be closed, but the preview version thereof may be accessed still (step S705). Similarly, the reminder will continuously pop up at the preview stage. When the mobile communication provider verifies the payment, the deduction for the payment can be conducted by a bill or by a value-stored mechanism.

If the user sends out a confirmation of the deduction for the payment to the mobile communication provider, the provider notifies the digital content provider (step S717). The message sent to the mobile communication provider shows the provider to be paid. The digital content provider generates the corresponding registration code to the mobile apparatus (step S719). The user may use the mobile apparatus to receive or download the registration code for decrypting the digital content. Therefore, the digital content can be fully accessed (step S721).

Referring to the above-described embodiments, the trading system of the present invention does not adopt the payment mechanism with possible doubt of security, such as transferring account via bank, or ATM machine. In contrast, the present invention conducts the payment through a bill for the fee of mobile communication that is a more efficient trading mechanism.

In practical technology, the present invention provides a convenient way for a user fully accessing the digital content without waiting for any confirmation as the user completes the purchase action. The user therefore can use the digital content immediately. The related registration is finished as receiving the registration code. The digital content provider particularly issues its own encryption algorithm, which corresponds to a specific way to generate the registration code, on the digital contents. The digital content provider even provides a specific method to transmit the registration code, such as a short message attached with the registration code, an electronic mail, or a registration on a web page.

To sum up the above description, the digital content trading system and method of the present invention are particularly adapted to a mobile apparatus capable of playing multimedia and wide-band network connectivity, a mobile communication provider and a digital content provider. A short message service is preferably incorporated to verifying the purchase action. Then the digital content can be fully accessed or downloaded from the digital content provider after the mobile communication provider verifies the payment. Consequently a commercial method of the digital content trading is accomplished.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A digital content trading method applied to a mobile apparatus, comprising:
initiating a digital content in the mobile apparatus;
transmitting a purchase signal from the mobile apparatus;
verifying the purchase signal by a mobile communication provider;
the mobile communication provider notifies a digital content provider;
the digital content provider transmitting a registration signal to the mobile apparatus; and
completing a registration, the digital content is fully accessed.

2. The method of claim 1, wherein the digital content is a full version of multimedia pre-installed in the mobile apparatus.

3. The method of claim 1, wherein the digital content is a part of multimedia pre-installed in the mobile apparatus.

4. The method of claim 3, wherein the multimedia is fully downloaded after registration.

5. The method of claim 1, wherein the digital content is decrypted after the mobile apparatus transmits the purchase signal, so as to temporarily access the non-registered but full digital content.

6. The method of claim 5, wherein if the multimedia with part content is pre-installed in the mobile apparatus, it is to download the non-registered but full multimedia which is temporarily accessed after transmitting the purchase signal.

7. The method of claim 6, wherein the non-registered multimedia is fully accessed in a period of time.

8. The method of claim 7, wherein if the multimedia is not registered as the time expires, the privilege of accessing the full version of digital content is closed.

9. The method of claim 1, wherein the digital content is the multimedia made by a selection from a pre-installed or a downloaded menu.

10. The method of claim 1, wherein the purchase signal is sent by a short message which is made by the mobile apparatus.

11. The method of claim 1, wherein when the mobile communication provider receives the purchase signal, a verification signal is transmitted to the mobile apparatus, and a user of the apparatus re-confirms the action.

12. The method of claim 11, wherein the user replies by a short message as he confirms the action.

13. The method of claim 12, wherein if the short message appears the purchase is discarded, the privilege of accessing the full digital content is closed.

14. The method of claim 1, wherein the registration signal is a serial number used to decrypt the multimedia.

15. The method of claim 1, wherein the mobile communication provider verifies the purchase action by a bill of deduction for the payment or an instant deduction by a value-stored card.

16. The method of claim 1, wherein when the mobile apparatus receives the registration signal, it appears a verification message of whether or not to receive a registration signal.

17. The method of claim 16, wherein if the registration signal is denied, the privilege of accessing the full digital content is closed.

18. A digital content trading system applied to a mobile apparatus, comprising:
a mobile apparatus, pre-installing one or more digital contents, having a digital content playing means, a communication means, and a decryption means, wherein the mobile apparatus decrypts privilege of fully accessing the digital content as receiving a registration signal;
a mobile communication provider providing a communication service and a payment service, wherein the mobile apparatus wirelessly connects with the mobile communication provider and thereby transmits the signal;
a digital content provider, including a database recording digital contents, having a wireless communication means, a digital content broadcasting means, and a registration code generating means, wherein the digital content provider transmits the registration signal based on an identification of the mobile apparatus after successfully conducting the payment.

19. The system of claim 18, wherein the digital content is the full or part of multimedia pre-installed in the mobile apparatus.

20. The system of claim 18, wherein the signal transmitted between the mobile apparatus and the mobile communication provider is implemented as a short message.

21. The system of claim 18, wherein the registration signal is a serial number used to decrypt the digital content.

22. The system of claim 18, wherein the payment service includes a service for payment by a bill and instant deduction by a value-stored card.
